(19) United States
(12) Patent Application Publication
(10) Pub. No.: US 2022/0397912 A1
(43) Pub. Date: Dec. 15, 2022

(54) SYSTEMS AND METHODS FOR DYNAMIC ROUTING AUTONOMOUS VEHICLES

(71) Applicants: 6 RIVER SYSTEMS, LLC, Waltham, MA (US); SHOPIFY INC., Ottawa (CA)

(72) Inventors: Catherine Jones FRANEY, Waltham, MA (US); Timothy DEIGNAN, Watertown, MA (US)

(21) Appl. No.: 17/345,800

(22) Filed: Jun. 11, 2021

(51) Int. Cl. G05D 1/02; B65G 1/137

(52) U.S. Cl. CPC G05D 1/0297; B65G 1/1373; G05D 2201/0216; G05D 1/0088

(57) ABSTRACT

Disclosed are systems and methods for dynamically routing autonomous vehicles to minimize the time spent navigating a warehouse. A system may dynamically route autonomous vehicles based on a weighted arrangement (or combination) of factors including: the route determined for other autonomous vehicles, the pick lists associated with the autonomous vehicles, the pick list priority, the picker's current location, the autonomous vehicles' current location, the picker's assignment to an autonomous vehicle, the picker's progress in completing his/her tasks, the picker's projected location, the autonomous vehicles' projected location, the nearest autonomous vehicle to a picker in time based on the picker's walking speed, the nearest autonomous vehicle in urgency, the nearest autonomous vehicle in distance, autonomous vehicle battery level, orders already placed on an autonomous vehicle, priority pickers, products to be picked that can be prioritized over other pickers and/or picking routes.

### TECHNICAL FIELD

This application relates generally to routing autonomous vehicles, and, more particularly, to dynamically routing autonomous vehicles to minimize the time spent navigating a warehouse.

### BACKGROUND

In an effort to increase pick rate and productivity in a warehouse, autonomous vehicles may lead and/or direct pickers around the warehouse based on various optimized routes. The autonomous vehicles in a warehouse guide pickers to pick products and place the products in specific containers (totes). Each container on the autonomous vehicle may be filled with products associated with one or more orders. When a picker has completed the order(s) on the autonomous vehicle, the picker may leave an autonomous vehicle behind and travel to a next autonomous vehicle at a “take-off” station, “waiting” station, or other designated meeting point. The autonomous vehicle may be ready to begin a new order, waiting to be assigned to a picker to pick products for orders.

### BRIEF DESCRIPTION OF THE DRAWINGS

The accompanying drawings constitute a part of this specification and illustrate embodiments of the subject matter disclosed herein.

FIG. 1A shows a system for dynamically revising a path for a picker to optimize the autonomous vehicles in a warehouse, according to an embodiment.

FIG. 1B illustrates a diagram of paths through a warehouse with various pick locations, according to an embodiment.

FIG. 2A shows an autonomous vehicle, according to an embodiment.

FIG. 2B shows a block diagram of an autonomous vehicle system that may be used in implementing the systems and methods described herein, according to an embodiment.

FIG. 2C shows an autonomous vehicle configured with multiple containers, according to an embodiment.

FIG. 3 shows operations of a method for dynamically routing a path for a picker to minimize the time pickers spend navigating a warehouse, according to an embodiment.

### DETAILED DESCRIPTION

Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

There remains a desire to maximize and/or enhance the optimality of utilization of autonomous vehicles. Autonomous vehicle resources are and/or include computing resources and are limited based on the resources in a given warehouse. Inefficient utilization of autonomous vehicles involves idling autonomous vehicles at takeoff stations, waiting stations, or other meeting points. Pickers using autonomous vehicles must walk to the location of the autonomous vehicle and identify the autonomous vehicle for use before continuing their assigned tasks, which can often delay operations and/or lengthen the route a picker must take. One or more secondary benefits may also result from maximizing and/or enhancing the optimality of the utilization of autonomous vehicle resources. For example, it may be that as a result of maximizing and/or enhancing the optimality of the utilization of autonomous vehicles, pick rates and productivity in a warehouse increase.

In order to maximize and/or enhance the optimality of the utilization of the autonomous vehicles, the system may optimally select autonomous vehicles based on one or more (or some combination thereof) factors including an autonomous vehicle's subsequent route and items to be collected, picker's current location, autonomous vehicles' current location, picker current route, progress in completing a pick list, picker's projected location, autonomous vehicles' projected location, nearest autonomous vehicles to a picker in time based on the picker's walking speed, nearest autonomous vehicle in urgency, nearest autonomous vehicle in distance, battery level, orders already placed on an autonomous vehicle, priority pickers, items to be picked that can be prioritized over other pickers and/or picking routes.

The system may execute various algorithms and/or weigh the factors to optimally select an autonomous vehicle in real time (or near real time). The system can also identify a meeting point (e.g., a location in a warehouse, an end of an aisle, a particular bin, a signpost) and/or a meeting time for the picker and/or autonomous vehicle, which may be optimized to reduce picker walking time.

The system can also identify a next best pick, where the system determines the next best pick based on one or more (or some combination) of factors including an autonomous vehicle's subsequent route and items to be collected, picker's current location, autonomous vehicles' current location, picker current route, progress in completing a pick list, picker's projected location, autonomous vehicles' projected location, nearest autonomous vehicles to a picker in time based on the picker's walking speed, nearest autonomous vehicle in urgency, nearest autonomous vehicle in distance, battery level, orders already placed on an autonomous vehicle, priority pickers, items to be picked that can be prioritized over other pickers and/or picking routes. For example, the system may select an autonomous vehicle based on the next best pick, where the next best pick is determined by the pick that is the shortest distance. In a different example, the system may select an autonomous vehicle based on the next best pick, where the next best pick is determined by the pick that is based on the orders already placed on an autonomous vehicle (e.g., a pick that may complete and order) and the picker's walking speed.

An autonomous vehicle routing system can dynamically revise and reconfigure autonomous vehicle routes to meet pickers at locations in the warehouse according to optimized locations and times. The system can transmit meeting locations and times to an electronic device operated by (or otherwise associated with) the picker. Specifically, the system may display a meeting time (or departure time) and location, directional instructions, and an identification of the autonomous vehicle on a handheld device operated by the picker, the autonomous vehicle itself, and/or on a digital display within the warehouse. In some configurations, the system can cause the autonomous vehicle to move to the meeting location at the meeting time. In other configurations, the system can cause the autonomous vehicles to move to the meeting location so the autonomous vehicles are optimized for upcoming pick tasks. For example, the system moves the autonomous vehicles to locations such that the autonomous vehicle is available for use as pickers pass by the autonomous vehicle (or become available by the autonomous vehicle by completing tasks).

The system may continuously/periodically monitor the location of different autonomous vehicles and pickers. At any given point in time, the system can identify a location of each autonomous vehicle. The system may also analyze various routes designated for each autonomous vehicle to identify a projected location of each autonomous vehicle. As a result, the system may determine a projected location of each autonomous vehicle within a defined amount of time (e.g., where the autonomous vehicle is going to be located in 4 minutes).

The system may also track the location of pickers and/or autonomous vehicles using location-aware sensors. For instance, each picker (and/or autonomous vehicle) may be equipped with an electronic device that is configured to be used to display information regarding the items to be collected (e.g., handheld device, wearable device). The electronic device may include a location-aware sensor that periodically transmits the location of the picker (and/or autonomous vehicle) to the system. Furthermore, the system may associate each picker (and/or autonomous vehicle) with a unique identifier and consider each picker's projected route. As a result, the system may know a current location and a projected location for each picker and/or autonomous vehicle.

The system may monitor the work progress and/or activity of each picker and/or autonomous vehicle. Pickers may use the handheld device to confirm that an item has been collected. The system may update a data record in real time and compare a list of items to be collected by each autonomous vehicle, then the system may identify whether the picker should be connected to a subsequent autonomous vehicle based on the location of pickers and autonomous vehicles.

The system may determine an autonomous vehicle's (and/or picker's) progress with the designated tasks and when the picker (and/or autonomous vehicle) should be connected to a subsequent autonomous vehicle. The system may also determine a route associated with the subsequent autonomous vehicle. For instance, the system may determine that upon completion of a first set of tasks, the picker should meet another autonomous vehicle to perform the tasks (e.g., a new pick list or a remaining portion of a pick list) associated with that autonomous vehicle.

To optimize (or improve) the utilization of autonomous vehicles in the warehouse, the system may determine whether the picker can be assigned to an autonomous vehicle that is already in the process of obtaining products on the pick list (i.e., not docked at the take-off station) or to another autonomous vehicle with a new pick list. Because the warehouse may have multiple pickers and multiple autonomous vehicles at any given time, the system may reassign pickers and autonomous vehicles, even if they are already designated to a particular pick list. For instance, if a first autonomous vehicle is instructed to go to another end of the warehouse for additional picks, a picker may be reassigned to a second autonomous vehicle that is nearby such that the picker can continue picking with the second autonomous vehicle instead. If the system does not find an autonomous vehicle that is already in use, the system may assign the picker to another autonomous vehicle that is located at the take-off station (i.e., a new autonomous vehicle). Using this method, the system may lead picks from the pick a picker just finished to a next best pick, where the next best pick is based on the one or more (or combination of factors) as described herein. The system may also balance pickers' routes and their corresponding autonomous vehicles, such that pickers are not always assigned to autonomous vehicles having a new pick list, increasing overall efficiency by shifting an emphasis away from starting new pick lists to finishing active pick lists.

Upon identifying the meeting location, meeting time, and which autonomous vehicle to assign to which picker, the system may transmit an instruction to the autonomous vehicle to move to the meeting location for the meeting time. The autonomous vehicle may also display an indicator to instruct which picker is designated to use that autonomous vehicle.

The system may also transmit an electronic notification to the picker such that the picker can walk to the meeting point for the meeting time. The notification may be displayed on the autonomous vehicle and/or the picker's mobile device (e.g., mobile phone, tablet, watch, glasses, or other wearables). For instance, a picker may be assigned a route and an autonomous vehicle, wherein the autonomous vehicle displays a hand off screen identifying the next autonomous vehicle for the picker. In some cases, the system may display real time directions that can navigate the picker to the meeting location. In another example, the system may display the directions and/or meeting location(s) using digital displays within the warehouse.

The system may account for erroneous selection of autonomous vehicle. For instance, if a picker starts operating an autonomous vehicle that is not assigned to the picker, the system may dynamically revise routes associated with other autonomous vehicle and pickers, meeting locations, and meeting times, such that the picker can continue his/her task, even though the picker selected a different autonomous vehicle.

Accounting for erroneous selections of autonomous vehicles reduces wasted resources (e.g., autonomous vehicle resources and time in the warehouse) by minimizing the effect of a picker operating an autonomous vehicle that was not assigned to the picker. For example, the autonomous vehicle that was supposed to be selected may not be utilized efficiently if the autonomous vehicle is erroneously abandoned. Further, the erroneously selected autonomous vehicle may be executing routing instructions/picking instructions that may not be optimal with respect to the picker that erroneously selected the autonomous vehicle. The system may account for erroneous selection of autonomous vehicles by dynamically reassigning the erroneously abandoned autonomous vehicle such that autonomous vehicle resources are not wasted.

In some configurations, the system may minimize erroneous selection of autonomous vehicles by temporarily holding an autonomous vehicle for a picker (e.g., placing a soft lock on the autonomous vehicle such that the vehicle will not be assigned to another picker for a period of time). The autonomous vehicle may be held, for instance, for the amount of time that system determines for the picker to reach the autonomous vehicle. In some implementations, other pickers may be locked out from selecting the autonomous vehicle (e.g., minimizing erroneous selection of autonomous vehicles). In other implementations, other pickers may not be locked out from selecting the autonomous vehicle.

### I. Components and Operations of Illustrative Systems

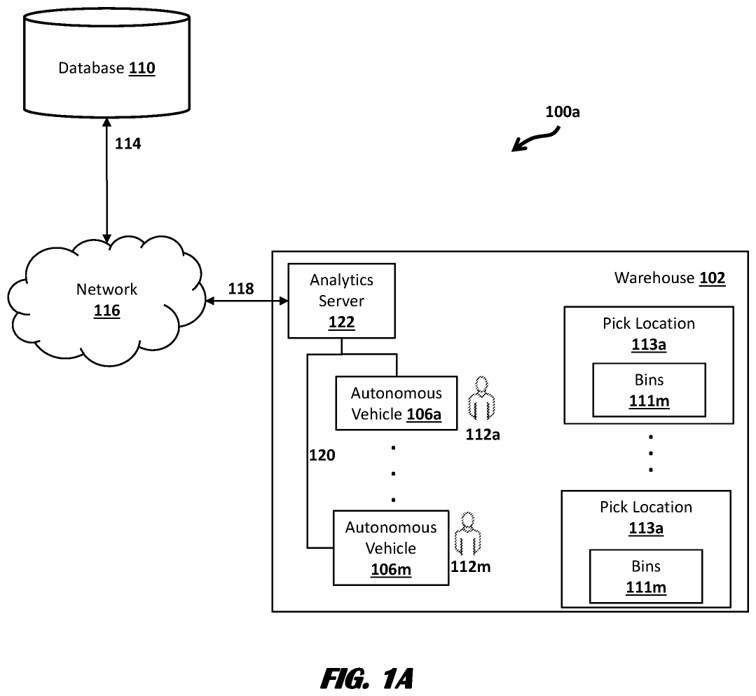

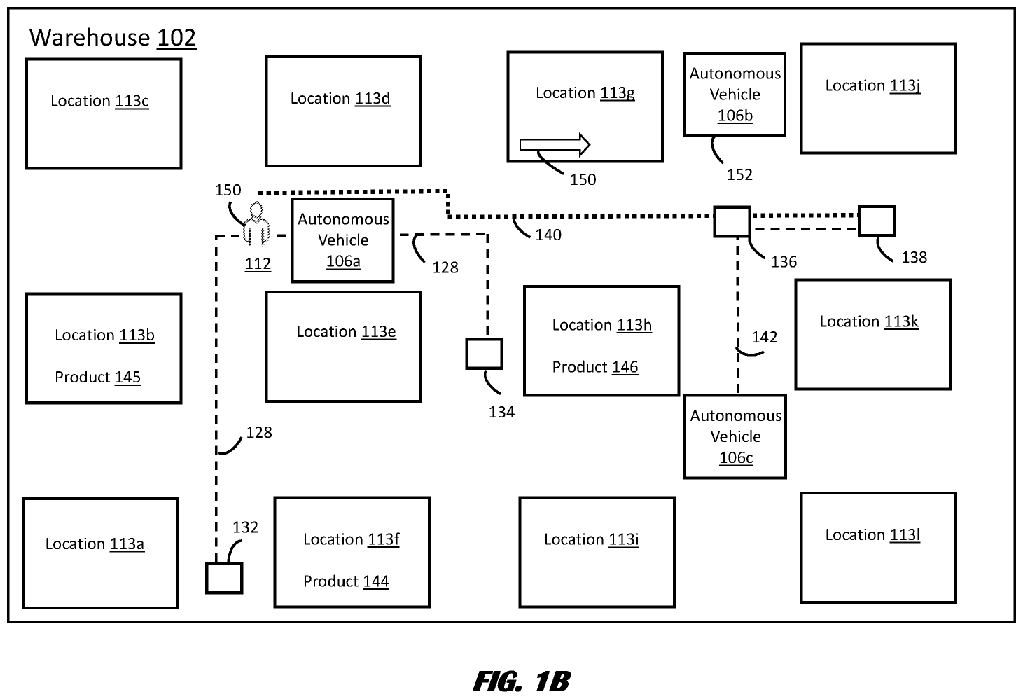

FIG. 1A illustrates a system 100a for dynamically revising a path for a picker to optimize the autonomous vehicles in a warehouse, according to an embodiment. The system 100a includes a database 110 connected to a communications network 116. The communications network 116 connects to an analytics server 122 associated with a warehouse 102. The warehouse 102 may contain autonomous vehicles 106a to 106m (collectively referred to as autonomous vehicle(s) 106), pickers 112a to 112m (collectively referred to as pickers 112), pick locations 113a to 113m (collectively referred to as pick locations 113), and shelves/racks/bins 111a to 111m (collectively referred to as bin(s) 111). Embodiments may include or otherwise implement any number of devices capable of performing the various features and tasks described herein. For example, FIG. 1A shows the analytics server 122 as a distinct computing device in the warehouse 102. In some embodiments, the analytics server 122 may be located in a different warehouse or capable of communicating with analytics servers 122 in various warehouses. Embodiments may comprise additional or alternative components, or may omit certain components, and still fall within the scope of this disclosure.

The databases 110 are coupled via communications links 114, to communications network 116, and via communications link 118 to the analytics server 122 associated with the warehouse 102. The communications network 116 may be a public or private network, and the communications links 114, and 118 that connect to communications network 116 may be wired or wireless. Non-limiting examples of the communications network may include: Local Area Network (LAN), Wireless Local Area Network (WLAN), Metropolitan Area Network (MAN), Wide Area Network (WAN), and the Internet. The communication over the network may be performed in accordance with various communication protocols, such as Transmission Control Protocol and Internet Protocol (TCP/IP), User Datagram Protocol (UDP), and IEEE communication protocols.

The databases 110 store and manage data records of various products. For example, databases 110 may store product quantities, product locations, product shipping schedules, product manufacturer information, and the like. The products in the warehouse 102 may be held, sold, maintained, stored, or otherwise transferred through the warehouse 102. The warehouse 102 may include a product storage facility or shipping depot, for example, for transitioning foods or products from one facility to a next or to a customer location (e.g., house, office).

The database 110 may also store data records indicating a quantity of a product and a location of a product in the warehouse 102 (e.g., in a bin 111 at a particular pick location 113). Some pick locations 113 contain bins 111 of one particular product. Some pick locations 113 contain bins 111 of multiple products. The database 110 may contain data records of the same product being stored in bins 111 in multiple pick locations 113.

The analytics server 122 is associated with warehouse 102 and may be physically located at the warehouse 102 or located remotely from warehouse 102. In the schematic embodiment shown in FIG. 1A, the analytics server 122 is shown as being located in the warehouse 102, which may represent a physical and/or remote location of the analytics server 122 or its functionality, though the analytics server 122 may be located in a remote location. The analytics server 122 may be implemented as a distributed system or as a single device. In the case of a distributed system, one or more processors located outside the warehouse or in other devices may be, and sometimes are, used to perform one or more operations attributed to the analytics server 122 in this embodiment.

The analytics server 122 may communicate with databases 110, autonomous vehicles 106, and devices associated with pickers 112 (e.g., mobile phones, personal data assistants (PDA), tablet computers, handheld scanners, or wearable devices such as watches, artificial reality glasses, and earpieces). For example, the analytics server 122 may communicate with one or more transceivers to transmit and receive information. The transceiver may transmit instructions to electronic devices, such as mobile or wearable devices of pickers 122 or autonomous vehicles 106, and/or receive product information, deadline information, carrier information and the like from databases 110. The autonomous vehicle 106 may communicate with the analytics server 122 via one or more transceivers, databases 110, and/or devices associated with pickers 112.

The analytics server 122 may receive product status information (e.g., whether a product at a pick location 113 has shorted), and completion of task information (e.g., product picks) associated with the pick path from the autonomous vehicle 106. The analytics server 122 may update data records in databases 110 in real time (or near real time) as products are being stocked and picked from pick locations 113 (including bins 111) in warehouse 102. Additionally or alternatively, the analytics server 122 may update data records in database 110 periodically (e.g., daily, monthly, quarterly). In some configurations, data records in database 110 are updated in response to trigger conditions (e.g., a shipment of a particular product arrives at the warehouse 102, a product is identified by a picker 112 as being out of stock).

The analytics server 122 may receive order information, directly or indirectly from customers, in real time (or near real time). The analytics server 122 may generate instructions for pickers 112 and associated autonomous vehicles 106 to retrieve one or more products in bins 111 from one or more pick locations 113 to complete an order or request from a customer (e.g., online order, pick list, customer's list, grocery list, shopping list). In some configurations, autonomous vehicles 106 are loaded with a number of containers based on the products to be picked in the warehouse 102 with one or more orders. Particular containers on the autonomous vehicle 106 may be assigned products from one or more orders such that when a picker 112 picks the product, the picker 112 is instructed to place the product into the particular container assigned to the product.

The analytics server 122 may cause instructions to display on the autonomous vehicle 106. The autonomous vehicle 106 may receive instructions from the analytics server 122, routing the autonomous vehicle 106 and picker 112 through the warehouse 102 to bins 111 at pick locations 113. In some configurations, the autonomous vehicle 106 may communicate with the database 110 to provide offline access to inventory data and/or product data.

The autonomous vehicle may display the path to the picker 112 assigned to the autonomous vehicle 106. The analytics server 122 may also cause instructions to display on a digital display within the warehouse 102. Additionally or alternatively, pickers 112 may utilize a mobile device (e.g., mobile phone, tablet, or a wearable device such as earpiece, glasses, watch, wrist computer) configured to receive instructions and/or notifications from the analytics server 122. In other embodiments, the autonomous vehicles 106 receive instructions and/or notifications from the analytics server 122 and transmit the instructions and/or notification to the pickers 112.

The instructions routing the autonomous vehicle 106 may indicate an order (e.g., a sequence) to provide or display the tasks for the path such that the tasks for individual products are provided or displayed one at a time, for example, in sequential order through an interface on the autonomous vehicle 106. The instructions may interleave picking products of various orders (e.g., lists of products for particular customers) such that the picker's time picking products in warehouse 102 is minimized. The autonomous vehicle 106 may display, using the instructions, one individual task at a time as a picker 112 progresses through the path such that upon completion of a first task (e.g., picking a first product at a first bin 111a at a first pick location 113a), the autonomous vehicle 106 displays a second task (e.g., picking a second product at a second bin 111b at the first pick location 113a, or picking a second product at a second bin 11b at a second pick location 113b).

The analytics server 122 may continuously (or periodically) monitor the location of different autonomous vehicles 106 and pickers 112 in the warehouse 102. In some configurations, the analytics server 122 may track (or monitor) the location of pickers 112 or autonomous vehicles 106 using location-aware sensors. For example, the analytics server 122 may track the autonomous vehicle 106 or wearable devices (e.g., electronic devices such as earpieces, glasses, watches, wrist computers) worn by the picker 112. The analytics server 122 may also use global positioning systems (GPS), beacon signal data, or other forms of signal data to identify a picker 112 and/or autonomous vehicle 106 at a particular location within the warehouse 102.

Additionally or alternatively, the analytics server 122 may determine a projected location of the autonomous vehicle 106 and/or picker 112. For example, the analytics server 122 may provide instructions to obtain products in a sequence (e.g., the path) at various bins 111 from one or more pick locations 113 to complete an order (or multiple interleaved orders). Accordingly, the analytics server 122 may determine a projected location of the autonomous vehicle 106 and associated picker 112 based on GPS information indicating the current location of the autonomous vehicle 106, information related to the next product to be picked according to the path, and a speed of a particular picker 112, an average speed of pickers 112, or a speed of an autonomous vehicle 106. The analytics server 122 may determine, for instance, the projected location of the autonomous vehicle 106 and/or picker 112 in the next four minutes.

The analytics server 122 may also approximately track the autonomous vehicle 106 based on receiving updates from the picker 112 and/or autonomous vehicle 106. The analytics server 122 may monitor (or track) a picker's 112 activity and work progress to determine the projected location. For example, the analytics server 122 may receive notifications every time the picker 112 picks a product for an order. The analytics server 122 may determine the projected location of the picker 112 and/or autonomous vehicle 106 based on the work progress of the picker, and information about the products being picked (e.g., the pick location 113 of the last product picked by the picker 112).

Additionally or alternatively, the analytics server 122 may receive a notification when the autonomous vehicle 106 (or picker 112) identifies a delay in picking products for the order. For example, the picker may identify a delay if a product is unavailable at a bin 111 and/or the product is damaged. The delay may indicate a deviation from the path and/or the timing associated with completing the path (or the order). The analytics server 122 may consider the delay and/or the work progress in determining the projected location.

The analytics server 122 may distinguish pickers 112 from other pickers 112 and/or from autonomous vehicles 106 by associating identifiers with each picker 112 and/or each autonomous vehicle 106. As a result, the analytics server 122 may receive and differentiate information from particular pickers 112 (or autonomous vehicles 106). For example, the analytics server 122 may determine a current location of a particular picker 112 (or autonomous vehicle 106) based on beacon signal data. Identifiers with each picker 112 may include, for example, numerical identifiers, colors, logos, and names.

When the picker 112 completes picking products associated with an order or request from the customer, the analytics server 122 may determine that the picker 112 should meet a subsequent autonomous vehicle 106 to perform tasks associated with a new pick list or a remaining portion of a pick list associated with the subsequent autonomous vehicle 106 such that the picker's 112 time spent walking to meet the subsequent autonomous vehicle is optimized 106 (e.g., the subsequent autonomous vehicle 106 is not idle waiting for the picker 112 for a defined duration of time). The picker 112 may also escort the autonomous vehicle 106 to a take-off station (e.g., a station where autonomous vehicles 106 are docked, loaded with containers, and initially assigned pickers 112) if the take-off station is understaffed, for example.

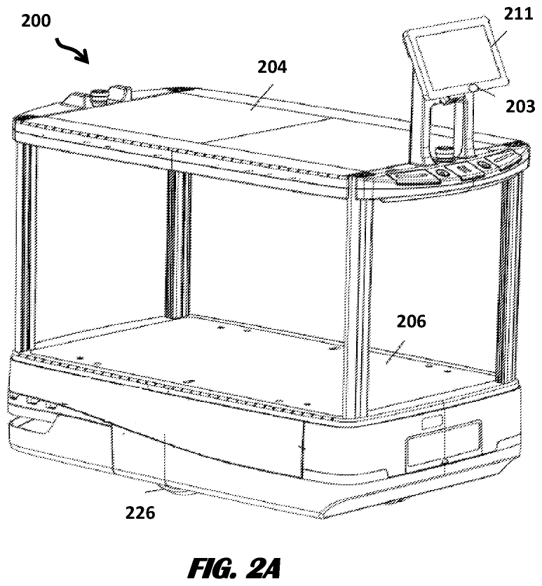

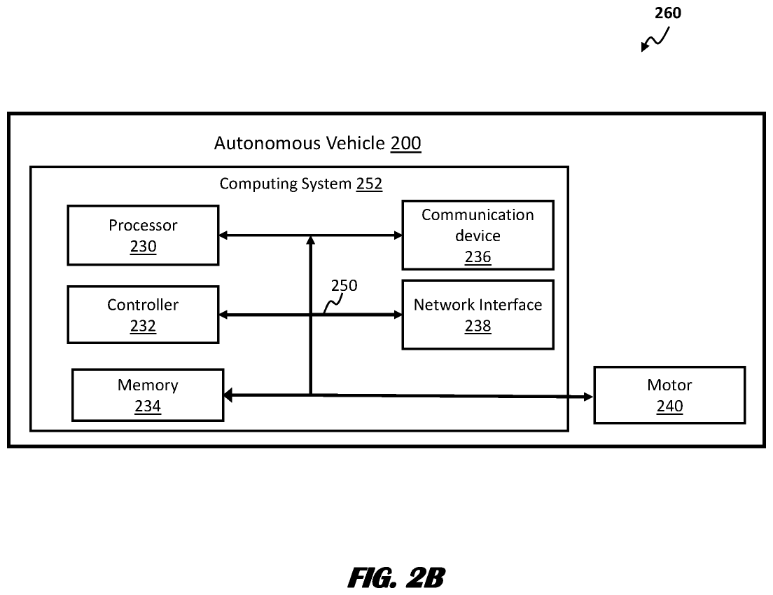

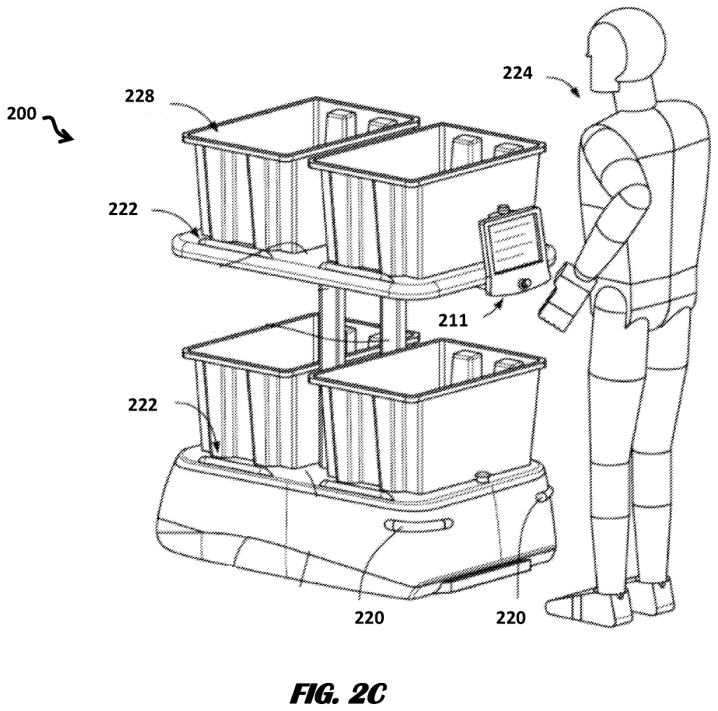

The analytics server 122 may determine whether to route the picker 112 to a subsequent autonomous vehicle 106 and/or a particular meeting location (or rendezvous location) to optimize the autonomous vehicles 106 in the warehouse 102. The analytics server 122 may compare a work progress of various autonomous vehicles 106, locations of autonomous vehicle 106 with respect to the position of the picker 112 (e.g., determined via GPS and/or schedule of pickers 112 and autonomous vehicles 106), and priority of orders to be picked associated with various autonomous vehicles 106. When the analytics server 122 identifies a subsequent autonomous vehicle 106 to route the picker 112 to, the analytics server 122 may display the picker's identifier (e.g., defined individual color, defined shift and/or group color, defined logo, picker identifier, and the like) on the identified subsequent autonomous vehicle 106 (e.g., via display 211 in FIG. 2C).

For example, the picker 112 finishing a pick list associated with a particular autonomous vehicle 106 may be instructed to meet a second autonomous vehicle 106 such that the picker 112 may assist with a pick list for the second autonomous vehicle 106.

The picker 112 may transition between, from, or to an autonomous vehicle 106, for example, if the picker's 112 shift is ending or if the picker 112 is scheduled to go on a break. Additionally or alternatively, the analytics server 122 may compare a list of products to be collected by each picker 112 (and/or a work progress) to identify whether the analytics server 122 should provide instructions to route the picker 112 to the subsequent autonomous vehicle 106 and/or a particular location.

The analytics server 122 may instruct the picker 112 to travel to a particular location to optimize the autonomous vehicles in the warehouse 102. The instructions may include a picker rendezvous location, a meeting (or rendezvous) time, a departure time (e.g., a departure time from a current or particular location in the warehouse 102), directional instructions, an identification of a subsequent autonomous vehicle 106 with subsequent pick lists to be picked by the picker 112, and an identification of a different picker 112 to meet the picker 112 at the rendezvous location.

Additionally or alternatively, at a time before the picker 112 completes picking products associated with an order (e.g., when the picker has picked a penultimate product for the order), the analytics server 122 may route the picker 112 to a subsequent autonomous vehicle 106 and/or a particular location in the warehouse.

The analytics server 122 may route the picker 112 to a subsequent autonomous vehicle 106 and/or a particular location in the warehouse based on the pick list progress or current (or projected) location of the picker 112 in the warehouse 102. For example, the analytics server 122 may determine that an order is languishing on an autonomous vehicle 106. The analytics server 122 may determine that the order is languishing if the autonomous vehicle 106 is idle (e.g., waiting for a picker 112 to arrive). The analytics server 122 may also determine that the order is languishing if a particular picker is picking products too slowly and/or is not equipped with the skills necessary to pick certain products (e.g., hazardous products, heavy products).

The analytics server 122 may determine how to route the autonomous vehicle 106 based on performance of a picker. The analytics server 122 may also determine that the picker 112 is not maintaining a certain pick rate based on the picker's 112 work progress. The pick rate may be an indication of the time that a picker 112 is spending in a warehouse 102. A high pick rate may indicate that the picker 112 is optimizing their time in the warehouse 102 by minimizing the time spent navigating to particular bin locations 113 in the warehouse 102 and/or other autonomous vehicles 106. Accordingly, before the off-track picker 112 continues picking products associated with the order, the analytics server 122 may route a different picker 112 to the autonomous vehicle 106 in an attempt to maximize and/or enhance the optimality of both pickers' 112 pick rates. Additionally or alternatively, the analytics server 122 may handoff a container associated with the order to a different autonomous vehicle 106.

The analytics server 122 may also route a picker 112 to a rendezvous location and/or a subsequent autonomous vehicle 106 even if the picker 112 has not completed picking the products associated with the order. For example, if a first autonomous vehicle 106 is instructed to go to a pick location 113 at an opposite end of warehouse 102 for additional picks, the analytics server 122 may reassign picker 112 associated with the first autonomous vehicle 106 to a second autonomous vehicle 106 that is nearby such that the picker 112 can continue picking with the second autonomous vehicle 106 instead or traveling with the first autonomous vehicle 106 to the pick location 113 at the opposite end of the warehouse 102.

The analytics server 122 may also evaluate, in real time (or near real time), the next best pick for the picker 112 upon completion of the picker's 112 pick. The analytics server 122 may assign the picker to another autonomous vehicle 106 based on one or more (or some combination of factors) including the autonomous vehicle's 106 subsequent route and items to be collected, another autonomous vehicle's 106 subsequent route and items to be collected, picker's 112 current location, autonomous vehicles' 106 current location (current autonomous vehicle 106 and/or another autonomous vehicle 106), picker 112 current route, progress in completing a pick list, picker's 112 projected location, autonomous vehicles' 106 projected location (current autonomous vehicle 106 and/or another autonomous vehicle 106), nearest autonomous vehicles 106 to a picker in time based on the picker's walking speed, nearest autonomous vehicle 106 in urgency, nearest autonomous vehicle 106 in distance, battery level, orders already placed on an autonomous vehicle 106, priority pickers 112, priority picks, items to be picked that can be prioritized over other pickers 112 and/or picking routes. For example, the analytics server 122 may select an autonomous vehicle 106 based on the next best pick, where the next best pick is determined by the pick that is the shortest distance. In a different example, the analytics server 122 may select an autonomous vehicle 106 based on the next best pick, where the next best pick is determined by the pick that is based on the orders already placed on an autonomous vehicle 106 (e.g., a pick that may complete and order) and the picker's 112 walking speed.

Additionally or alternatively, the analytics server 122 may assign the picker 112 to another autonomous vehicle 106 that is located at a take-off station (e.g., a new autonomous vehicle 106 that has not been assigned a picker 112). The analytics server 122 may balance the route navigating the picker 112 and corresponding autonomous vehicle 106, such that picker 112 is not always assigned to autonomous vehicles 106 having a new pick list, increasing overall efficiency by shifting an emphasis away from starting new pick lists to finishing active pick lists . For example, the analytics server 122 may determine whether the picker 112 is assigned to an autonomous vehicle 106 already in use (e.g., not docked at the take-off station) or assign another autonomous vehicle 106 with a new pick list to the picker 112 based on the pick lists of active (e.g., not docked autonomous vehicles 106), projected locations, travel times, deviated distances, and the like.

In the event the picker 112 starts picking products for an autonomous vehicle 106 that was not assigned to the picker 112 (e.g., the picker 112 selects a autonomous vehicle 106 at a take-off station not assigned to the picker 112), the analytics server 122 may dynamically revise routes associated with other autonomous vehicles 106 and pickers 112, rendezvous locations, rendezvous times, departure times, and the like, such that the picker 112 can continue picking products associated with the autonomous vehicle 106 even though the picker 112 selected a different autonomous vehicle 106 from the autonomous vehicle that the analytics server 122 identified.

In some configurations, depending on the capacity (or the expected capacity and/or fill volume) of containers of each of the autonomous vehicle 106, the analytics server 122 may not revise the routes associated with other autonomous vehicles 106 but instead update the pick list associated with orders on the other autonomous vehicles 106 (and the autonomous vehicle 106 the picker 112 selected in error). The analytics server 122 may update the pick list (or pickers 112 assigned to autonomous vehicles 106) of each of the autonomous vehicles 106 to optimize a particular picker's 112 pick rate and/or maximize and/or enhance the optimality of a number of pickers' 112 pick rate. For example, the analytics server 122 may update the pick list such that a picker 112 picks products of various orders stored at the same pick location 113 in the warehouse.

FIG. 1B illustrates a diagram of paths through a warehouse 102 with various pick locations 113, which may be a bin in a location of one or more bins or a shelf in a location of one or more shelves. The path 128 can include or correspond to an original or initial path generated based on the pick locations 113 of products in warehouse 102. The path 128 can provide a route through the warehouse 102 for an autonomous vehicle 106 and picker 112 to follow to select or retrieve products 144-146 associated with one or more orders. The path 128 corresponds to a minimal or smallest total distance for the autonomous vehicle 106 to travel through the warehouse 102 to select and/or retrieve the products for one or more orders from the different pick locations 113 within the warehouse 102.

The autonomous vehicle 106 can execute the instructions to collect the products in a determined order. The determined order of products to be picked is a sequential order based in part on a position on the path 128, a current location 150 in the warehouse 102, and/or a location of a product at a pick location 113.

For example, the autonomous vehicle 106 can execute instructions for picking products associated with a pick list associated with a single location 113f. Upon determining that a product from the pick list is damaged and/or unavailable (e.g., detecting that a weight of a container is not an expected weight, receiving an indication and/or notification from a picker 112 that a product is damaged and/or unavailable), the autonomous vehicle 106 may execute instructions for picking the damaged and/or unavailable product at a second location 113b (e.g., an alternate location).

In a different example, the autonomous vehicle 106 can execute instructions for a first location 113f for a first product 144 and wait to execute instructions for a second location 113b for a second product 145 until the autonomous vehicle 106 receives an indication that the first product 144 has been picked. Additionally or alternatively, the autonomous vehicle 106 may receive an indication that the first product 144 is unavailable and/or damaged.

The path 128 can include a take-off point 132 and an end point 134 with each of the pick locations 113 at different points along the path 128. It should be appreciated that the path 128 can include a single location 113a or multiple locations 113 (e.g., pick locations 113a-113l) with the number of pick locations 113 on path 128 determined based in part on a number of products 144-146 picked for one or more orders.

The autonomous vehicle 106 can execute the instructions and traverse the path 128 selecting and retrieving the corresponding products 144-146 from the respective locations 113. For example, the picker 112a may pick product 144 from location 113f, pick product 145 from location 113b, and pick product 146 at location 113h.

Upon completing the pick tasks associated with the autonomous vehicle 106a (e.g., picking products 144-146), the picker 112 may return to the take-off point 132 to be assigned to a new autonomous vehicle. Alternatively, the analytics server 122 may transmit instructions navigating the picker 112 to a second autonomous vehicle (e.g., autonomous vehicle 106b or 106c depending on the routing criteria).

In some configurations, the analytics server 122 navigates the picker 112 to the autonomous vehicle 106c because the autonomous vehicle 106c is closer than the autonomous vehicle 106b. In other configurations, the analytics server 122 may navigate the picker 112 to the autonomous vehicle 106b in response to a projected location of the autonomous vehicle autonomous vehicle 106b. For example, autonomous vehicle 106c may be traveling away from the picker 112 while autonomous vehicle 106b may be traveling toward the picker 112. Accordingly, a projected location of a product to be picked with autonomous vehicle 106b may be closer (e.g., take less time for the picker to walk to) than a projected location of a product to be picked with autonomous vehicle 106c.

The analytics server 122 can transmit instructions for the picker's path to the new autonomous vehicle (e.g., autonomous vehicle 106b or 106c depending on the routing criteria). In some embodiments, the autonomous vehicle 106 can dynamically update, using the instructions, the display of the picker's path. Alternatively, wearable technology on the picker can dynamically update, using the instructions, the display of the picker's path.

In a configuration where the analytics server determines that a picker should proceed to another autonomous vehicle, the analytics server 122 routes the picker 112 and the autonomous vehicle 106c to a location 138 near location 113j. The analytics server 122 may calculate a path 140 for the picker 112 to location 138 and may also calculate a path 142 for the autonomous vehicle 106c to the location 138. The analytics server 122 may optimize the route by navigating both the picker 112 and autonomous vehicle 106c to meet at a waypoint 136 before the destination location 138. Picker 112 and autonomous vehicle 106c may then travel together to the location 138. The waypoint 136 may represent a rendezvous location on a way to a destination and does not require the waypoint to have a picking task for the pick list. In some instances, the autonomous vehicle 106c may be instructed to arrive at the waypoint 136 to wait for the picker 112. In other instances, the autonomous vehicle 106c may be instructed to arrive at the waypoint 136 at the same time as the picker 112. The autonomous vehicle 106c may provide further routing instructions to assist picker 112 to travel to location 138 from waypoint 136.

The analytics server 122 may navigate the picker 112 using various directional indications. As discussed herein, navigating the picker 112 may optimize (or improve) the use of other autonomous vehicles 106 in the warehouse 102. The analytics server 122 communicates via transceiver, which transmits instructions for a directional indication. The transceiver can transmit to an electronic device, such as a mobile device or wearable device of a picker, an autonomous vehicle, or other device, such as a sign or indicator in a warehouse. For example, the analytics server 122 may navigate the picker 112 to location 136, 138 using instructions displayed (or projected audibly) from the autonomous vehicle, a mobile device, or a wearable device associated with the picker 112. Additionally or alternatively, the analytics server 122 may navigate the picker 112 to locations 136, 138 using directional indicators such as an arrow 150. For example, the shelves along an aisle in location 113g may illuminate with arrow 150. The arrow 150 may illuminate in a color associated with the picker 112. The arrow 150 may remain illuminated while the picker 112 is in a vicinity of the arrow 112.

### II. Autonomous Vehicles

A worker (e.g., picker) may pick products from bins or shelves at particular locations in a warehouse or other storage facility and load the picked products on an autonomous vehicle. The picker may travel with the autonomous vehicle to one or more packing (also called packout) stations such that the products on the autonomous vehicle may be unloaded and packed for shipping. The picker may also travel with the autonomous vehicle to one or more healing stations such that containers containing orders with shorted products may be removed from the autonomous vehicle and the containers (and associated orders) may be integrated into pick paths of other autonomous vehicles. The healing station may take alternative action to otherwise cure a shorted order.

The system can be configured for robotics to replace or assist the pickers. In some implementations, a robotic autonomous vehicle may move autonomously throughout the warehouse or storage facility. When moving autonomously, the autonomous vehicle can move alongside a picker or independently of a picker to locations in the warehouse. In other implementations, the robotic autonomous vehicle can pick products from bins or shelves and load the picked products onto the autonomous vehicle. The robotic autonomous vehicle may also place products from the autonomous vehicle onto bins or shelves.

As shown in FIG. 1A, autonomous vehicles 106 are located in the warehouse 102 and controlled by the analytics server 122 via communications link 120. Pickers 112 may work alongside the autonomous vehicles 106 to perform operations (e.g., pick products from bins 111 in the warehouse 102 and place those products in the autonomous vehicle 106, replenish bins 111 in the warehouse by stocking products on the bins using the products in an autonomous vehicle 106, and remove products from the autonomous vehicle 106 such that the products may be unloaded and packaged for shipping). In the example used herein, the autonomous vehicle is robotic and has autonomous operation based on instructions communicated from the analytics server 122. In some embodiments, the autonomous vehicle 106 may be manually operated by a picker 112, who may push, pull, drive, or otherwise move the autonomous vehicle 106 around the warehouse 102. For example, the autonomous vehicle 106 may have a shopping cart configuration. A manually-operated autonomous vehicle 106 may still use other components for communicating with the analytics server 122 and the picker 112, such as a screen for communicating information to the picker 112 from the analytics server 122.

FIG. 2A shows an autonomous vehicle 200, according to an embodiment. The autonomous vehicle 200 has wheels 226, display 211, speaker 203 and two shelves 204, 206. In some instances, weighing scales (not shown) may be incorporated into the shelves 204, 206. For instance, the shelves may include pressure plates. The autonomous vehicle 200, through notifications displayed on display 211 and/or audio instructions provided via speaker 203, may notify a worker of the total weight of products on the shelves 204, 206 (e.g., the weight of the products on each shelf 204 and 206 respectively, the weight of combined shelves 204, 206). One or more containers (as described in FIG. 2C) can be, and sometimes are, transported on each of the shelves 204, 206 of the autonomous vehicle 200. The scales may have a tare feature such that the weight of containers on the scales can be zeroed. Eliminating the weight of the container on the scale allows the analytics server to determine the weight of the products in the container.

While a two-shelf autonomous vehicle embodiment is shown, multiple autonomous vehicle configurations are possible, with some autonomous vehicles being implemented using a single shelf while other autonomous vehicles have two or more shelves. Each of the containers on the autonomous vehicle may have several levels (layers, zones) for storing and transporting the picked products.

The autonomous vehicle 200 may be configured to determine product dimensions. For instance, a weighing autonomous vehicle may utilize shelves 204, 206 with scales to weigh the products. Additionally or alternatively, a measuring autonomous vehicle may carry one or more measuring devices (e.g., augmented reality measurement tools, rulers, measuring tape) and/or be configured with an imaging system such that the processor (230 in FIG. 2C) on the autonomous vehicle may determine the size of the product (e.g., depth, width, height). For example, the processor may perform object recognition to measure the product such that the imaging processing may recognize a product and even distinguish it from a hand of a picker. In some instances, the processor may support object recognition capabilities and/or be capable of executing the imaging system. The processor may determine the dimensions of the product and communicate the product dimensions to the analytics server (122 in FIG. 1). Additionally or alternatively, the analytics server may receive image data (raw data, compressed data) from the imaging system and perform object recognition to determine the dimensions of the products placed on the autonomous vehicle 200. The autonomous vehicle 200 may be configured for both weighing products and measuring the sizes of products.

The autonomous vehicle 200, through visual instructions displayed on display 211 and/or audio instructions provided via speaker 203, may transmit an instruction to place one or more products on an inspection station. For example, a picker assigned to an autonomous vehicle 200 may receive instructions from the autonomous vehicle 200 to pick a product to be inspected on route to a location (e.g., such as an inspection station, a subsequent product location, etc.) Additionally or alternatively, an administrator (using a management console, for instance), may trigger an inspection. That is, a management console or other administrative device may transmit an instruction (via display 211, speaker 203, and/or wearable devices worn by the picker) to place one or more products on an inspection station, place one or more products on an autonomous vehicle 200 on route to a location, and the like.

The autonomous vehicle 200 may also act as the inspection station. Inspection stations may also include designated areas of the warehouse in which a product is weighed and/or measured. Additionally or alternatively, the autonomous vehicle 200, through visual instructions displayed on display 211 and/or audio instructions provided via speaker 203, may transmit an instruction to measure one or more products using equipment in the warehouse (e.g., measuring tape, rulers, or scales).

FIG. 2B shows a block diagram of an autonomous vehicle system 260 that may be used in implementing the systems and methods described herein, according to an embodiment. The computing system 252 of an autonomous vehicle 200 may include a processor 230, a controller 232, a memory 234, a communication device 236, and a network interface 238. The autonomous vehicle 200 may also include a motor 240. Each of the components 230, 232, 234, 236, 238, and 240 may be interconnected, for example, using a system bus 250. General-purpose computers, network appliances, mobile devices, or other electronic systems may also include at least portions of the computing system 252.

The computing system 252 may receive and/or obtain information about a customer order (e.g., from the analytics server), including a list of products, the dimensions of the products, the weight of the products, characteristics of the products (a fragility score, a hazard score), the priority of the order relative to other orders, the target shipping date, the carrier pick up time, whether the order can be shipped incomplete (without all of the ordered items) and/or in multiple shipments, etc.

The controller 232 may be configured to send control signals to the motor 240 and/or other components of the autonomous vehicle 200 as described further herein. The motor 240 may be configured to convert electrical energy received from an electrical power source (e.g., battery, super capacitor, etc.) into rotations of the wheels (226 in FIG. 2B). The motor 240 propels the autonomous vehicle 200 such that the autonomous vehicle 200 moves autonomously and does not require being pushed or pulled by a human or other force.

The memory 234 stores information within the computing system 252. In some implementations, the memory 234 is a non-transitory computer-readable medium. In some implementations, the memory 234 is a volatile memory unit. In some implementations, the memory 234 is a non-volatile memory unit.

The memory 234 may store warehouse operation information. The warehouse operation information may include documented product dimensions, container capacity (e.g., weight limit, product count limit), shelf capacity (e.g., weight limit, product count limit), and bin capacity (e.g., weight limit, product count limit). The memory 234 may also store product information such as a product name, a product description, a product image, and product storage location.

The processor 230 is capable of processing instructions for execution within the computing system 252. In some implementations, the processor 230 is a single-threaded processor. In some implementations, the processor 230 is a multi-threaded processor. The processor 230 is capable of processing instructions stored in the memory 234.

The processor 230 in the autonomous vehicle 200 (and/or the analytics server 122 in FIG. 1A) controls the autonomous vehicle's 200 movement to/from one location (e.g., pick location) to the next location (e.g., unloading station, subsequent pick location). The processor 230 may be in communication with controller 232 and/or motor 240. In the event the autonomous vehicle 200 becomes associated with a different worker (e.g., a worker at an unloading station or a second picker taking over picking for the first picker), the autonomous vehicle 200 may require the second worker to log in to the autonomous vehicle 200 (e.g., via the touch screen 211 in FIG. 2A) prior to the autonomous vehicle 200 providing guidance as to the next operation performed by the second worker.

In some implementations, at least a portion of the approaches described herein may be realized by instructions that upon execution cause one or more processing devices to carry out the processes and functions described herein. Such instructions may include, for example, interpreted instructions such as script instructions, or executable code, or other instructions stored in a non-transitory computer readable medium.

The network interface 238 may be configured to receive and transmit messages and/or instructions. The network interface 238 may be a wireless network interface capable of receiving commands and information from the analytics server and sending information (e.g., product locations) to the analytics server via wireless signals.

The network interface 238 may be configured to process signals from the analytics server and/or other autonomous vehicles in the warehouse. The network interface 238 may be, for instance, an Ethernet card, a serial communication device, e.g., an RS-232 port, and/or a wireless interface device, e.g., an 802.11 card, a 3G wireless modem, or a 4G wireless modem.

FIG. 2C shows the autonomous vehicle 200 configured with multiple containers 228, according to an embodiment. The autonomous vehicle 200 may display on screen 211 instructions for a picker 224. The instructions may instruct the picker 224 to travel to locations in the warehouse, search for particular bins at a particular location for particular products, and place products in the containers 228 or remove products from the containers 228 (e.g., unload at a particular bin/shelf). The picker 224 may place (or remove) the product in a particular container 228 based on lights 222, 220 indicating the particular container. That is, the lights 222, 220 may illuminate, directing the picker 224 to place (or remove) the product in the indicated container 228. Additionally or alternatively, the display 211 may display instructions instructing the picker 224 which container 228 to place (or remove) the products.

Additionally or alternatively, one or more imaging systems (e.g., scanners) may operate in conjunction with (or replace) lights 220, 222. The imaging system may be used to measure the dimensions of products as the products enter the container. For example, object recognition may be performed to recognize a product and even distinguish it from a hand of a picker 224. As discussed herein, the processor (230 in FIG. 2B) may support object recognition capabilities and/or be capable of executing the imaging system. Additionally or alternatively, the analytics server (122 in FIG. 1) may receive image data (raw data, compressed data) from the imaging system and perform object recognition to determine the dimensions of the products entering the containers 228. The imaging systems may confirm whether a product has been placed into the container. If the product is not placed into the container, the analytics server may determine that the product is shorted.

The display 211 and/or speaker may instruct the picker 224 to place the product directly on the autonomous vehicle 200. In such a scenario, the picker 224 may not load or operate the autonomous vehicle 200 with four containers 228. Rather, the picker 224 may load the autonomous vehicle 200 with two containers 228, for instance, and reserve space on the autonomous vehicle 200 for large or bulky products.

### III. Illustrative Methods of Operation

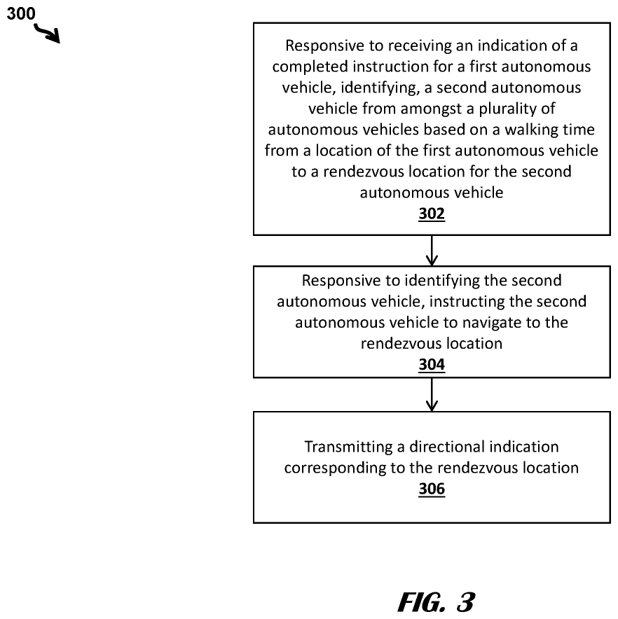

FIG. 3 shows operations of executing a method 300 for routing autonomous vehicles and pickers to minimize the time pickers spend navigating a warehouse by maximizing and/or enhancing the optimality of the utilization of autonomous vehicles, according to an embodiment. While operations of executing the method 300 are described with respect to two autonomous vehicles, the analytics server may perform operations in parallel to route multiple autonomous vehicles. The method may be implemented by an analytics server (or other computing device) associated with the warehouse and executes machine-readable software code for determining a route for a picker based on weighing various factors. Some embodiments may include additional, fewer, or different operations than those described in the method 300 and shown in FIG. 3. The various operations of the method 300 may be performed by one or more processors executing on any number of computing devices.

An order includes at least one product. The autonomous vehicle may be configured to hold one or more containers, where each container is configured to contain products associated with one or more orders. Additionally or alternatively, products associated with one or more orders may be placed directly on the autonomous vehicle.

Containers associated with multiple orders may be associated with (assigned to, carried on) an autonomous vehicle (as shown in FIG. 2C). For example, orders may be grouped in a container and associated with an autonomous vehicle based on deadlines (e.g., each of the orders to be picked using the autonomous vehicle must be shipped by 3 pm tomorrow). Orders may also be grouped in a container and associated with an autonomous vehicle based on products (e.g., each of the products to be picked using the autonomous vehicle are perishable). Additionally or alternatively, one container may be associated with one order.

Orders may also be grouped in multiple containers associated with multiple autonomous vehicles (e.g., the order is shared by multiple autonomous vehicles). For example, an order may have perishable products and non-perishable products. The products of the order associated with the perishable products may be associated with (e.g., assigned to) a first autonomous vehicle and picker picking perishable products of one or more other orders. The products of the order associated with the non-perishable products may be associated with a second autonomous vehicle and picker picking non-perishable products of one or more other orders.

The analytics server may determine an initial pick path for the autonomous vehicle and picker based in part on the products associated with each of the orders. In some configurations, the initial pick path is based in part on the distance of each of the products stored at product locations in the warehouse. For example, the analytics server may determine the initial pick path based on minimizing the time that the picker spends in the warehouse. That is, the analytics server may determine the initial pick path based on minimizing the distance that the picker travels in the warehouse.

In some configurations, an instruction may be considered a single task. For example, an instruction may be obtaining a particular product at a location in the warehouse or walking to a designated location in the warehouse (e.g., a particular aisle, a sign in the warehouse, a rendezvous location, or meeting another autonomous vehicle). In other configurations, the instruction may be a series of tasks. For example, an instruction may be completing an order. Completing the order may include fulfilling the order (e.g., picking each of the products in an order), arriving at a packing station so that the order can be packaged for a delivery service, providing the order to the delivery service, and the like.

In operation 302, responsive to receiving an indication of a completed instruction for a first autonomous vehicle, the analytics server may identify a second autonomous vehicle from among a plurality of autonomous vehicles. In some configurations, the completed instruction may be based upon a completed pick list of the autonomous vehicle where the picker obtained each of the products associated with an order on an autonomous vehicle. In other configurations, the completed instruction may be based on a completed pick of a product on the autonomous vehicle. If the completed instruction is based on the completed pick and additional products must be picked in the order to complete the order, the indication of the completed instruction may include an estimated time until the completion of the pick list (e.g., the estimated completion time of picking the products in a particular order and/or the estimated completion time of picking the products in all of the orders associated with the autonomous vehicle). The indication may be a change in a data record indicating the completed instruction, thereby causing the analytics server to identify the second autonomous vehicle.

In order to optimize the selection of autonomous vehicles, the analytics server may consider a weighted arrangement (or combination) of factors including: the route determined for autonomous vehicles, the pick lists associated with the autonomous vehicles, the pick list priority (e.g., based on customer priority, deadline priority, perishable product priority), the picker's current location, the autonomous vehicles' current location, the picker's assignment to an autonomous vehicle (and the current route of the autonomous vehicle), the picker's progress in completing his/her tasks, the picker's projected location, the autonomous vehicles' projected location, nearest autonomous vehicle to a picker in time based on the picker's walking speed, the nearest autonomous vehicle in urgency, the nearest autonomous vehicle in distance, the battery level, the orders already placed on an autonomous vehicle, the priority pickers (e.g., based on skillset for example driving a forklift, or handling hazardous material), the products to be picked that can be prioritized over other pickers and/or picking routes.

The analytics server may execute various algorithms to optimize the selection of the autonomous vehicle, which can occur in real time based on the positioning of the autonomous vehicles and pickers around the warehouse. The system can also identify a meeting point (e.g., a rendezvous location, a handoff point), other location (e.g., an aisle, a particular bin, a signpost, or any other location in the warehouse) and/or a time for the picker (e.g., a rendezvous time or a departure time) which may be optimized to reduce picker travel time.

The analytics server may statistically or algorithmically determine weights for the factors based on, for example, minimizing the effect of rerouting any autonomous vehicle on high priority orders, minimizing the time of a picker picking products in the warehouse, minimizing the number of orders delayed (based on maximum time remaining and travel time, as discussed further herein), among others. Additionally or alternatively, a user (such as a supervisor) may input weights for each of the factors in the weighted arrangement.

In identifying (or selecting the optimal) second autonomous vehicle from among the plurality of autonomous vehicles, the analytics server may consider a travel time. The travel time may be based on a distance to a rendezvous location (a meeting location with a subsequent autonomous vehicle) or other location (e.g., a location of a subsequent pick for a product). The distance to the location in the warehouse may be converted into time units based on the picker's walking pace and/or the pace of the autonomous vehicle. The picker's walking pace may be specific to that particular picker (obtained by the analytics server via metrics retrieved from wearable technology, historic picker order completion time information) or an average walking pace.

The analytics server may identify the second autonomous vehicle based on comparing distances to rendezvous locations (or product locations in the warehouse) and associated travel times of each of the autonomous vehicles in the plurality of autonomous vehicles.

For example, in some configurations, the analytics server may compare a travel time (or distance) associated with navigating to a rendezvous location of first autonomous vehicle in the plurality of autonomous vehicles to a travel time (or distance) associated with navigating to rendezvous location of a second autonomous vehicle in the plurality of autonomous vehicles. The analytics server may identify an optimal autonomous vehicle with respect to a particular picker's location in the warehouse in response to identifying a rendezvous location associated with the autonomous vehicle and the corresponding smallest travel time. In other configurations, the analytics server may compare a travel time (or distance) associated with navigating to rendezvous locations of each of the autonomous vehicles in the plurality of autonomous vehicles and subsequent picks associated with the autonomous vehicle currently assigned to the picker. For example, the analytics server may select an autonomous vehicle as the second autonomous vehicle in response to determining a smallest travel time of an autonomous vehicle associated with navigating to a projected location of the picker. In yet other configurations, the analytics server may compare a travel time (or distance) associated with navigating to projected locations of each of the autonomous vehicles in the plurality of autonomous vehicles. The analytics server may identify the second autonomous vehicle based in part on comparing the travel times (or distance) of each of the projected locations of the plurality of autonomous vehicles to projected locations of a picker (or first autonomous vehicle).

In identifying the second autonomous vehicle from among the plurality of autonomous vehicles, the analytics server may also consider subsequent picks in a pick list. For example, the analytics server may determine that a subsequent pick associated with an autonomous vehicle is not optimal for the picker. The subsequent pick may not be optimal for the picker if the subsequent pick is located far away (e.g., exceeds a threshold distance). The threshold distance may consider one or more (or some combination of) factors including distance of each item in the pick list for the first autonomous vehicle, distance for each item in the pick list for the second autonomous vehicle, location within a warehouse for each pick for each autonomous vehicle, picker's current location (or projected location), current location (and projected location) of each autonomous vehicle, current route, progress in completing a pick list, picker's walking speed, closest other autonomous vehicles, battery level, orders already placed on an autonomous vehicle, priority pickers, priority picks (e.g., of each subsequent pick in a pick list and/or a next pick in the pick list), items to be picked that can be prioritized over other pickers and/or picking routes, and a situation of other autonomous vehicles. When the first autonomous vehicle requires the picker to travel beyond a threshold distance, the analytics server may optimize routing of autonomous vehicles to assign pickers to minimize a travel distance. For example, the analytics server may determine that the subsequent pick is far away based on a travel time. Additionally or alternatively, the subsequent pick may not be optimal for the picker if the subsequent pick is too heavy for the picker. For example, the analytics server may compare the product weight to one or more picker attributes. Picker attributes may include a weight limit associated with each particular picker. Additionally or alternatively, the subsequent pick may not be optimal for the picker if the subsequent pick requires special handling. For example, the analytics server may compare a product attribute to a picker attribute. Product attributes may include hazard attributes, fragile attributes, or special handling attributes (e.g., forklift). Picker attributes may include picker skills such as operating a forklift and/or being certified to picker hazardous and/or fragile products.

In identifying the second autonomous vehicle from among the plurality of autonomous vehicles, the analytics server may also consider the pick lists of the plurality of autonomous vehicles. For example, an autonomous vehicle in the plurality of autonomous vehicles may be instructed, using the initial pick path, to navigate to the same aisle, bin location, shelf location, or other waypoint that the picker is located (or will be located). Accordingly, the analytics server may identify the autonomous vehicle already instructed to navigate to the picker (or a projected location of the picker) as the second autonomous vehicle selected from the plurality of autonomous vehicles.

Additionally or alternatively, the analytics server may compare deviated distances of each of the autonomous vehicles in the plurality of autonomous vehicles. The deviated distance may be a distance deviating from the initial pick path to meet the picker. In some configurations, the travel time may be based on the deviated distance. For example, the analytics server may identify the second autonomous vehicle by comparing the deviated distances of each of the autonomous vehicles to navigate to the location of the picker (or a projected location of the picker). The analytics server may identify the autonomous vehicle with the shortest deviated distance (or travel time) to navigate to the picker (or a projected location of the picker) as the autonomous vehicle selected from the plurality of autonomous vehicles.

Additionally or alternatively, the analytics server may identify an autonomous vehicle from a plurality of autonomous vehicles in the event an autonomous vehicle is associated with an outstanding task. Outstanding tasks associated with autonomous vehicles may include pick tasks, unload tasks, or pack tasks. Additionally or alternatively, the analytics server may identify an autonomous vehicle in the event the autonomous vehicle needs assistance (e.g., autonomous vehicle is stuck or is otherwise prevented from moving along a pick path).

The analytics server may also identify an autonomous vehicle from a plurality of autonomous vehicles in response to identifying an autonomous vehicle with a higher priority pick list than a pick list associated with an autonomous vehicle currently assigned to a picker. In one example, a pick list may be of higher priority if the products in the pick list are perishable. Additionally or alternatively, a pick list may be of higher priority if the order associated with the products is approaching a deadline or a portions of products in the pick list are associated with a high priority order (e.g., an order placed by a high priority customer).

The analytics server may compute a maximum time remaining (the time remaining to complete the order before a deadline) for each order on an autonomous vehicle based on a current time. The analytics server may determine that an order is completed (fulfilled) based on picking each of the products identified in the order. Additionally or alternatively, the maximum time remaining may include the time to pick and/or pack the order (e.g., prepare the order for shipment by unloading the products from the autonomous vehicle and packing the products for shipment). The maximum remaining time for the order may also depend on a ship-by time (e.g., a time that the order may be packed and ready to be shipped such that the order arrives to the customer by the promised time). Additionally or alternatively, the maximum remaining time for the order may depend on a carrier cut-off time (e.g., each carrier may set a timing deadline based on the last time of the day the carrier will be at the warehouse).

In other configurations, the analytics server may identify a waypoint location in the warehouse and instruct the picker to navigate to the waypoint location. The waypoint location may include a pick location, a bin location, an aisle, a signpost in the warehouse, a takeoff station, a packing station, among others.

In operation 304, responsive to identifying the second autonomous vehicle, the analytics server may instruct the second autonomous vehicle to navigate to the rendezvous location. The rendezvous location may be a location at any workflow location (e.g., a location on the initial path associated with the autonomous vehicle, a future location on the initial path associated with the autonomous vehicle (e.g., the analytics server may rearrange the order of picking products), a waypoint (e.g., a bin location, an aisle, a signpost, a takeoff station, a packing station, in front of a break location)), a meeting location, or any other location in the warehouse. The analytics server may route (or re-route) autonomous vehicles at takeoff and/or at any time during workflow.

In some configurations, the analytics server may route the second autonomous vehicle (or picker associated with the second autonomous vehicle) to a rendezvous location (or other location) of the first autonomous vehicle. In other configurations, the analytics server may re-route both the first and second autonomous vehicles (and/or the first and/or second pickers) to the rendezvous location (or other location) That is, the analytics server may transmit instructions to both the first and second autonomous vehicles to meet at the rendezvous location.

Additionally or alternatively, the analytics server may re-route only the first autonomous vehicle (or picker associated with the first autonomous vehicle) to the rendezvous location. For example, the first autonomous vehicle may receive instructions from the analytics server to travel to the rendezvous location and retrieve a container on the second autonomous vehicle.

The analytics server may identify a rendezvous time, a departure time (e.g., a time to depart from the current location in the warehouse such that the autonomous vehicle and/or picker arrive at the rendezvous location or waypoint location at the rendezvous time), a travel time (e.g., the expected time to reach the rendezvous location), among others.

The analytics server may display a graphical indicator on a display (e.g., display 211 in FIG. 2C, a display on mobile device, display on a wearable device worn by the picker, or a display in the warehouse). For example, a warehouse display may provide color coordinated directions to various pickers, where each picker is associated with a color and navigates through the warehouse by following the graphical indicators in their color.

The graphical indicator may also be a notification to the picker associated with the autonomous vehicle that the autonomous vehicle is being rerouted. The graphical indicator may also display a location. For example, the graphical indicator may indicate an aisle, bin number, shelf, or general direction (e.g., left, south). The graphical indicator may also display a map of the warehouse and present a high level path through the aisles of the warehouse to navigate the picker to the subsequent location in the warehouse. The graphical indicator may indicate the direction (or location) that the autonomous vehicle is traveling in and/or the direction (or location) that the picker should travel in. For example, the autonomous vehicle may be rerouted to a subsequent picker, and the picker may be rerouted to a subsequent autonomous vehicle.

In some configurations, the analytics server may transmit directions displayed on the graphical indicator sequentially. For example, the analytics server may transmit a next direction in response to determining that the picker has completed a current direction (e.g., based on monitoring the picker's location in the warehouse) Additionally or alternatively, the analytics server may transmit the entire sequence of directions at one time (e.g., each of the directional operations may be transmitted and displayed to the picker).

In some configurations, the rendezvous location (or waypoint) is transmitted. That is, the analytics server may only transmit the rendezvous location (or waypoint).

The graphical indicator may also display other information such as an alternate picker identifier (e.g., a subsequent picker replacing the picker associated with the autonomous vehicle) and/or a time such (e.g., the time the picker is expected to return from break, the time the picker is expected to return another day).

In operation 306, the analytics server may transmit a directional indication corresponding to the rendezvous location. The directional indication may be displayed on a display (e.g., display 211 in FIG. 2C, a display on an electronic device, display on a wearable device worn by the picker, or a display in the warehouse). The directional indication is similar to structure and function to the graphical indicator described in operation 304. For example, the directional indication may indicate a direction, location, bin, aisle, and the like using graphical arrows, lights, colors, audible directions, or other positive reinforcement techniques.

While in some configurations, the graphical indicator may provide information regarding the route (or reroute) from the perspective of the second autonomous vehicle (e.g., the autonomous vehicle selected from the plurality of autonomous vehicles), the directional indication in operation 306 may provide information regarding the route (or reroute) from the perspective of the picker traveling to the second autonomous vehicle. For example, the graphical indicator may display a notification indicating that a reroute is in progress, while the directional indication may display sequential directions on wearable technology worn by the picker navigating the picker to the second autonomous vehicle.

In some configurations, the analytics server may instruct the picker to transfer a container carried on the first autonomous vehicle to the second autonomous vehicle. The second autonomous vehicle will have different orders and/or time constraints.

In one embodiment, a computer-implemented method may comprise responsive to receiving an indication of a completed instruction for a first autonomous vehicle, identifying, by a processor, a second autonomous vehicle from amongst a plurality of autonomous vehicles based on a travel time from a location of the first autonomous vehicle to a rendezvous location for the second autonomous vehicle; responsive to identifying the second autonomous vehicle, instructing, by the processor, the second autonomous vehicle to navigate to the rendezvous location; and transmitting, by the processor to an electronic device, a directional indication corresponding to the rendezvous location.

The indication may be based upon a completed pick list for the first autonomous vehicle.

The indication may include an estimated time until completion of a pick list.

The rendezvous location may include a waypoint to a second location.

Identifying the second autonomous vehicle may be based in part on a projected location for each of the plurality of autonomous vehicles, and further comprising comparing the projected location for each of the plurality of autonomous vehicles with a projected location of the first autonomous vehicle.

The method may further comprise responsive to identifying the second autonomous vehicle, causing, by the processor, the second autonomous vehicle to display a graphical indicator.

The second autonomous vehicle may be identified responsive to receiving the indication of the completed instruction for the first autonomous vehicle and responsive to the first autonomous vehicle receiving an instruction for a subsequent pick beyond a threshold distance.

Identifying the second autonomous vehicle may comprise determining that the second autonomous vehicle has a higher priority pick list than the first autonomous vehicle.

The directional indication may include at least one of an identification of the rendezvous location or directions to the rendezvous location.

Identifying the second autonomous vehicle may also comprise comparing a travel time associated with navigating to the rendezvous location of each of the autonomous vehicles in the plurality of autonomous vehicles to a projected location of the first autonomous vehicle.

In another embodiment, a computer system may comprise a processor configured to: responsive to receiving an indication of a completed instruction for a first autonomous vehicle, identify a second autonomous vehicle from amongst a plurality of autonomous vehicles based on a travel time from a location of the first autonomous vehicle to a rendezvous location for the second autonomous vehicle; and responsive to identifying the second autonomous vehicle, instruct the second autonomous vehicle to navigate to the rendezvous location; and a transceiver configured to transmit to an electronic device a directional indication to the rendezvous location.

The indication may be based upon a completed pick list for the first autonomous vehicle.

The indication may include an estimated time until completion of a pick list.

The rendezvous location may include a waypoint to a second location.

Identifying the second autonomous vehicle may be based in part on a projected location for each of the plurality of autonomous vehicles, and wherein the processor is further configured to compare the projected location for each of the plurality of autonomous vehicles with a projected location of the first autonomous vehicle.

The processor may be further configured to responsive to identifying the second autonomous vehicle, causing the second autonomous vehicle to display a graphical indicator.

The processor may be further configured to identify the second autonomous vehicle responsive to receiving the indication of the completed instruction for the first autonomous vehicle and responsive to the first autonomous vehicle receiving an instruction for a subsequent pick beyond a threshold distance.

Identifying the second autonomous vehicle may comprise determining that the second autonomous vehicle has a higher priority pick list than the first autonomous vehicle.

The directional indication may include at least one of an identification of the rendezvous location or directions to the rendezvous location.

Identifying the second autonomous vehicle may also comprise comparing a travel time associated with navigating to the rendezvous location of each of the autonomous vehicles in the plurality of autonomous vehicles to a projected location of the first autonomous vehicle.

In yet another embodiment, a non-transitory machine-readable storage medium having computer-executable instructions stored thereon that, when executed by one or more processors, may cause the one or more processors to perform operations comprising: responsive to receiving an indication of a completed instruction for a first autonomous vehicle, identifying a second autonomous vehicle from amongst a plurality of autonomous vehicles based on a travel time from a location of the first autonomous vehicle to a rendezvous location for the second autonomous vehicle; responsive to identifying the second autonomous vehicle, instructing the second autonomous vehicle to navigate to the rendezvous location; and transmitting, to an electronic device, a directional indication corresponding to the rendezvous location.

The foregoing method descriptions and the process flow diagrams are provided merely as illustrative examples and are not intended to require or imply that the operations of the various embodiments must be performed in the order presented. The operations in the foregoing embodiments may be performed in any order. Words such as “then,” “next,” etc. are not intended to limit the order of the operations; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The operations of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method comprising:
responsive to receiving an indication of a completed instruction for a first autonomous vehicle, identifying, by a processor, a second autonomous vehicle from amongst a plurality of autonomous vehicles based on a travel time from a location of the first autonomous vehicle to a rendezvous location for the second autonomous vehicle;
responsive to identifying the second autonomous vehicle, instructing, by the processor, the second autonomous vehicle to navigate to the rendezvous location; and
transmitting, by the processor to an electronic device, a directional indication corresponding to the rendezvous location.

2. The method of claim 1, wherein the indication is based upon a completed pick list for the first autonomous vehicle.

3. The method of claim 1, wherein the indication includes an estimated time until completion of a pick list.

4. The method of claim 1, wherein the rendezvous location is a waypoint to a second location.

5. The method of claim 1, wherein identifying the second autonomous vehicle is based in part on a projected location for each of the plurality of autonomous vehicles, and further comprising comparing the projected location for each of the plurality of autonomous vehicles with a projected location of the first autonomous vehicle.

6. The method of claim 1, further comprising:
responsive to identifying the second autonomous vehicle, causing, by the processor, the second autonomous vehicle to display a graphical indicator.

7. The method of claim 1, wherein the processor identifies the second autonomous vehicle responsive to receiving the indication of the completed instruction for the first autonomous vehicle and responsive to the first autonomous vehicle receiving an instruction for a subsequent pick beyond a threshold distance.

8. The method of claim 1, wherein identifying the second autonomous vehicle comprises determining that the second autonomous vehicle has a higher priority pick list than the first autonomous vehicle.

9. The method of claim 1, wherein the directional indication includes at least one of an identification of the rendezvous location or directions to the rendezvous location.

10. The method of claim 1, wherein identifying the second autonomous vehicle comprises comparing a travel time associated with navigating to the rendezvous location of each of the autonomous vehicles in the plurality of autonomous vehicles to a projected location of the first autonomous vehicle.

11. A computer system comprising:
a processor configured to:
responsive to receiving an indication of a completed instruction for a first autonomous vehicle, identify a second autonomous vehicle from amongst a plurality of autonomous vehicles based on a travel time from a location of the first autonomous vehicle to a rendezvous location for the second autonomous vehicle, and
responsive to identifying the second autonomous vehicle, instruct the second autonomous vehicle to navigate to the rendezvous location; and
a transceiver configured to transmit to an electronic device a directional indication to the rendezvous location.

12. The system of claim 11, wherein the indication is based upon a completed pick list for the first autonomous vehicle.

13. The system of claim 11, wherein the indication includes an estimated time until completion of a pick list.

14. The system of claim 11, wherein the rendezvous location is a waypoint to a second location.

15. The system of claim 11, wherein identifying the second autonomous vehicle is based in part on a projected location for each of the plurality of autonomous vehicles, and wherein the processor is further configured to compare the projected location for each of the plurality of autonomous vehicles with a projected location of the first autonomous vehicle.

16. The system of claim 11, wherein the processor is further configured to:
responsive to identifying the second autonomous vehicle, causing the second autonomous vehicle to display a graphical indicator.

17. The system of claim 11, wherein the processor is further configured to identify the second autonomous vehicle responsive to receiving the indication of the completed instruction for the first autonomous vehicle and responsive to the first autonomous vehicle receiving an instruction for a subsequent pick beyond a threshold distance.

18. The system of claim 11, wherein identifying the second autonomous vehicle comprises determining that the second autonomous vehicle has a higher priority pick list than the first autonomous vehicle.

19. The system of claim 11, wherein the directional indication includes at least one of an identification of the rendezvous location or directions to the rendezvous location.

20. The system of claim 11, wherein identifying the second autonomous vehicle comprises comparing a travel time associated with navigating to the rendezvous location of each of the autonomous vehicles in the plurality of autonomous vehicles to a projected location of the first autonomous vehicle.

21. A non-transitory machine-readable storage medium having computer-executable instructions stored thereon that, when executed by one or more processors, cause the one or more processors to perform operations comprising:
responsive to receiving an indication of a completed instruction for a first autonomous vehicle, identifying a second autonomous vehicle from amongst a plurality of autonomous vehicles based on a travel time from a location of the first autonomous vehicle to a rendezvous location for the second autonomous vehicle;
responsive to identifying the second autonomous vehicle, instructing the second autonomous vehicle to navigate to the rendezvous location; and
transmitting, to an electronic device, a directional indication corresponding to the rendezvous location.
